(19) United States
(12) Patent Application Publication
(10) Pub. No.: US 2020/0253136 A1
(43) Pub. Date: Aug. 13, 2020

(54) PROTECTION BAGS AND RELATED METHODS

(71) Applicants: Jonathan Sherman Stillman, Laguna Niguel, CA (US); Eric James Hibbard, Colorado Springs, CO (US)

(72) Inventors: Jonathan Sherman Stillman, Laguna Niguel, CA (US); Eric James Hibbard, Colorado Springs, CO (US)

(21) Appl. No.: 16/785,442

(22) Filed: Feb. 7, 2020

Related U.S. Application Data
(60) Provisional application No. 62/803,093, filed on Feb. 8, 2019.

(51) Int. Cl. A01G 13/10; B65D 85/52; B65D 30/00; B65D 33/28; A01G 13/04; A01G 13/02; A01G 31/02

(52) U.S. Cl. CPC A01G 13/105; B65D 85/52; B65D 29/00; A01G 31/02; A01G 13/043; A01G 13/0237; B65D 33/28

(57) ABSTRACT

Protective bags having bag bodies formed by or with meshed fabrics can be used to protect potted plants from plant bugs. The protective bags are sized and shaped to protect both the plant top section and the plant root system or just the plant root system. Accessible seams or windows can be provided to access the interior of a bag for watering, feeding plant food, and/or pruning purposes. The protective bags can be sized and shaped to work with potted plants using soils or hydroponic systems.

### FIELD OF ART

The present disclosure is generally directed to protection bags with specific discussions on protection bags made from porous fabrics or cloths and related methods for use to protect plants and vegetables from plant bugs.

### BACKGROUND

Farmers and homeowner/vegetable growers alike are familiar with the variety of plant bugs that can wreak havoc to young plants and crops. Plant bugs typically fall into two different categories of bugs, namely the lygaeid family of bugs and the miridae family of bugs. These bugs have been known to feed on plants, trees, grasses, berries, and cereals.

Plant bugs also have different eating habits that range from sucking the juices from garden plants to infesting plants with eggs. In a single crop season, the bugs can also multiply over several generations, with up to five generations known in certain species.

Another form of bugs that eat plants is known as the root aphids. They represent a growing problem especially among indoor growers. They can be hard to spot due to their relatively small sizes and are often colored to blend with roots and soils. Collectively, these different types of bugs can be called plant bugs.

A proven and simple way to control plant bugs is through the use of certain pesticides and fertilizers. However, for organic food growers, such methods may not be a viable option.

### SUMMARY

Aspects of the invention include a method for protecting a plant having a plant top section and a plant root system. The method can comprise the steps: providing a protective bag having a bag body defining an interior, a first end, and a second end; placing the plant root system inside the interior of the bag body through the first end; closing the first end; and wherein the protective bag is made from a meshed-material sheet or fabric.

The second end can be provided with an end meshed sheet that is attached to a second end perimeter.

The bag body can be provided with one or more seams.

The bag body can be provided with one or more accessible windows.

The meshed-material sheet or fabric can be made from a PTFE coated fiberglass fabric or from non-woven fabric.

The method can comprise placing the protective bag into a dug-up hole in the ground.

The plant can be grown in a hydroponic system.

The meshed-material sheet or fabric can have a mesh size of less than 2 mm.

The meshed material sheet or fabric can have at least one fold.

The method can comprise placing the protective bag into a wooden container.

The method can comprise placing both the plant top section and the plant root system inside the interior of the bag.

A further aspect of the invention is a protective bag for use with a potted plant, said protective bag comprising: a bag body defining an interior, a first end, and a second end; the bag body being made from a meshed-material sheet or fabric; a closing mechanism at the first end for closing the first end, said closing mechanism comprising at least one of stitching, bonding, welding, stapling, snap-fittings, ZIPLOCK, VELCRO, buttons, zippers, or combinations thereof; and wherein the protective bag body is sized and shaped to accommodate an entire plant's top section and plant root system or just the plant root system.

Other aspects and features of the protective bags and related methods are contemplated and are further described below in the detailed section of the written description.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a schematic view of a potted plant located inside a protective bag in accordance with aspects of the invention.

FIGS. 1A and 1B are alternative applications of the protective bag.

FIG. 2 is a hydroponic system comprising a plurality of plants located inside a protective bag in accordance with aspects of the present invention.

FIG. 2A shows an alternative application of the protective bags with a hydroponic system.

FIGS. 3-8 are schematic views of different embodiments of protective bags in accordance with aspects of the invention.

FIGS. 9-12 are schematic views of different closing mechanisms in accordance with aspects of the invention.

FIG. 13 is yet another alternative application of the protective bag.

FIG. 14 is still yet another alternative application of the protective bag.

### DETAILED DESCRIPTION

The detailed description set forth below in connection with the appended drawings is intended as a description of the presently preferred embodiments of protection bags provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

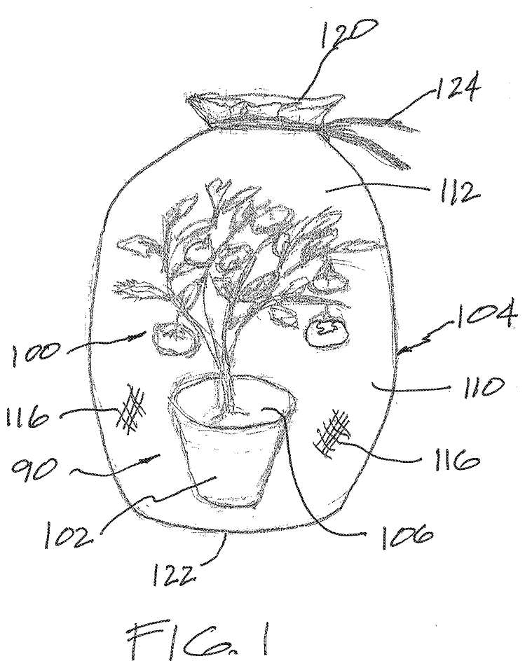

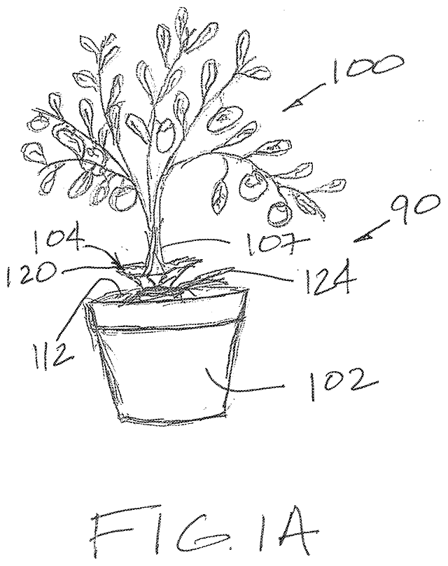

With reference now to FIG. 1, a schematic view of a potted plant 90 comprising a plant 100 positioned inside a pot 102 and the combination located inside a protective bag 104 is shown, which can also synonymously be referred to as a protection bag. In an example, the potted plant 90 can generically represent any number of plants, vegetables, or young trees that can be planted inside a pot 102. The plant 100 can have its root system supported in soil 106. Alternatively, the plant 100 can be grown using a hydroponic system in which the root system of the plant 100 is supported by an inert medium, such as perlite, rockwool, clay pellets, peat moss, vermiculite or other known hydroponic system inert mediums.

In an example, the protective bag 104 comprises a body 110 defining an interior 112 for accommodating the potted plant 90. The protective bag 104 is configured to close in the potted plant 90, including the plant's root system, inside the interior 112 of the bag for an extended period to provide the plant with a protective cover during the growth cycle of the plant to harvest time, or until such time that the plant process for commercialization. Thus, the protective bag 104 is configured to surround the plant to protect the plant from harmful plant bugs over an extended period. If the plant 100 is actually a young tree, the young tree can remain inside the protective bag 104 until it is deemed strong enough to be planted in the ground. Thus, no matter the plant type 100, the present protective bag 104 is configured to provide a protective cover for the plant, including the root system of the plant, over an extended period of days, weeks or months. In the example with a young tree, the young tree can be planted into the ground with the protective bag 104 and the tree's root system can simply break through the material of the bag as the tree grows.

To provide the plant 100 with water and nutrients while located inside the protective bag 104 for extended periods, the protective bag 104 can be made from a porous material so that water, UV light, plant food, and oxygen can pass through the body 110 of the bag and reach the plant. For example, an external irrigation system can be provided that sprays water and/or mist to the potted plant contained inside the protective bag, which passes through the porous bag to reach the plant. Additionally or alternatively, the protective bag 104 can include means to enable access to the interior 112 for watering the plant and/or feeding the plant with plant food. However, the porosity of the protective bag 100 should be limited to a mesh size 116, schematically shown, that is no larger than the smallest plant bug that the bag is configured to keep out from entering the interior of the bag once the bag is sealed. Some of the plant bugs are known to be as small as about 2 mm long, or about 1/13-inch. Thus, the mesh size 116 for the protective bag 104 should be selected accordingly. Further, an array of protective bags can be provided with different mesh size options for use in different regions that face different plant bug problems.

Plant food as used herein can be understood to generically cover any substance, such as manure, mixture of nitrates, or organic fertilizer derived from animal or vegetable matter, that makes the soil or the hydroponic system more fertile.

With continued reference to FIG. 1 and as further discussed below, the protective bag 104 is sized and shaped to accommodate the potted plant 90 and is provided with sufficient capacity to accommodate the potted plant for the projected duration and growth of the plant 100. Further, the protective bag 104 is sized and shaped to accommodate not just the plant, but also the root system and the pot or the base used to support the root system. If a plant has a plant top section, which includes the trunk or branches, the leaves and flowers and/or fruits, and a root system, the protective bag 104 is configured to protect the plant from plant bugs that may attack both the plant top section and the root system.

To fit the potted plant 90 inside the interior of the protective bag 104, the bag can be provided with at least one main opening 120 opposite an enclosed bottom 122 and optionally one or more seams to allow the body 110 to be expanded at the one or more seams to provide access to the interior 112 or to enlarge the main opening 120 to facilitate placement of the potted plant into the interior. Each seam can open and can close using adhesive, VELCRO, snap buttons, ZIPLOCK, and similar means. The main opening 120 can also close using similar closing means after placement of the potted plant into the interior. Optionally, a drawstring 124 may be used at the main opening 120 to close in and seal the main opening after placement of the potted plant into the interior, as further discussed below. Still optionally, the protective bag can have two main openings at opposite ends of the bag with both openings having means for closing the openings, such as drawstrings, VELCRO, etc.

In use, water and/or plant food can be sprayed to the exterior of the protective bag 104 and the plant 100 can receive the water and plant food through the porous body 110. Alternatively or in addition thereto, an irrigation system can be piped through a sealable window or seam on the bag 104 to provide water and nutrients to the root system of the plant 100. The window and/or seam can be provided with closing means to close around the piping system to maintain a protective environment from plant bugs.

Alternatively, rather than an irrigation system, the interior of the bag can be accessed through a window, a pocket, or a seam provided with the bag body to provide access and enable the plant to be watered and/or fed with plant food.

With reference now to FIG. 1A, an alternative embodiment of the protective bag 104 is shown, which is sized and shaped to accommodate and protect the plant's 100 root system only. The protective bag 104 can be similar to the protective bag shown in FIG. 1 but sized and shaped differently for a different application. That is, in the present embodiment, the protective bag 104 is configured to for use to protect the plant's root system from root aphids. As shown, the plant 100 is planted in soil and the root system with the soil positioned inside the interior 112 of the protective bag and then tightened by a draw string 124 around the trunk 107. The bag can made from a porous material as previously described so that water and/or plant food can be delivered to the plant's root system through the porous layer of the protective bag. In alternative embodiments, the root system can be supported by an inert medium, such as perlite, rockwool, clay pellets, peat moss, vermiculite or other known hydroponic system inert mediums. In some examples, rather placing the root system and support system of the plant inside the protective bag and into a pot, the combination can be planted into the ground.

With reference now to FIG. 1B, a protective bag 104 is shown with a potted plant 90 in accordance with further aspects of the invention, which is sized and shaped to accommodate and protect the plant's 100 root system only, like that of FIG. 1A. However, in the present embodiment, the protective bag 104 is sized and shaped for use to protect the plant's root system from root aphids and for use around the outside of the pot 102. As shown, the plant 100 is planted in soil and the root system with the soil positioned in a pot and the combination located inside the interior 112 of the protective bag 104 and then tightened by a draw string 124 around the trunk 107. The bag 104 can made from a porous material as previously described so that water and/or plant food can be delivered to the plant's root system through the porous layer of the protective bag. In alternative embodiments, the root system can be supported by an inert medium, such as perlite, rockwool, clay pellets, peat moss, vermiculite or other known hydroponic system inert mediums.

With reference now to FIG. 2, a hydroponic system 140 comprising a base 142 defining a plant bed with an array of plant receptacles 144 are shown, each with a plant 100. Each plant receptacle 144 can have an inert medium, such as perlite, rockwool, clay pellets, peat moss, or vermiculite for supporting the respective plant's root system. In an example, the plant bed 142 comprises an array of six plant receptacles 144 each with a plant 100. In some examples, there can be fewer numbers of plants than the number of plant receptacles. In other examples, there can be a different number of plant receptacles than six and different number of plants.

The hydroponic system 140 can be piped or plumbed with an irrigation system, which can project through one of the sides 150 or through the base bottom 152 of the base. In some examples, the irrigation system can be piped through two or more of the sides 150 and/or through the base bottom 152. In other examples, the hydroponic system 140 does not incorporate any irrigation system but receives water and plant food instead by spraying the same through the porous material of the protective bag.

A support frame 158 can be provided with the base or plant bed 142. The support frame 158 can embody a number of interconnected rods or tubes 160 and can be shaped to provide support for a protective bag 104. The frame 158 can have a number of cross-braces and branches to support different shaped plants 100, number of plants, and different shaped base 142.

The hydroponic system 140 can represent any number of prior art hydroponic systems for growing any number of plants 100. As previously described, the plants 100 can be protected from plant bugs by placing a protective bag 104 around the base 142 and the frame 158. In an example, the protective bag 104 can be sized and shaped to fit over and accommodate the hydroponic system 140. The protective bag 104 can have one or more seams 164 that function as an opening to receive the hydroponic system or that allow the bag to open up to then wrap around to cover the hydroponic system. The seams 164 can also be used to access the interior 112 of the bag to enable watering, pruning, and/or feeding plant food to the plants.

In an example, the protective bag 104 can have a multi-sided shape, can embody an extruded tube that is then sealed at the two open ends of the extrude tube, a sheet that is folded widthwise or lengthwise in half and then sealed along a common edge, or made from a number of panels that are welded, bonded, or stitched together to form an enclosure, as further discussed below. The protective bag 104 can be made from a material having a mesh 116 with a mesh size that is sufficiently small to prevent plant bugs from entering but large enough for water, oxygen, UV light, and/or plant food to enter via the porous material of the bag body of the bag.

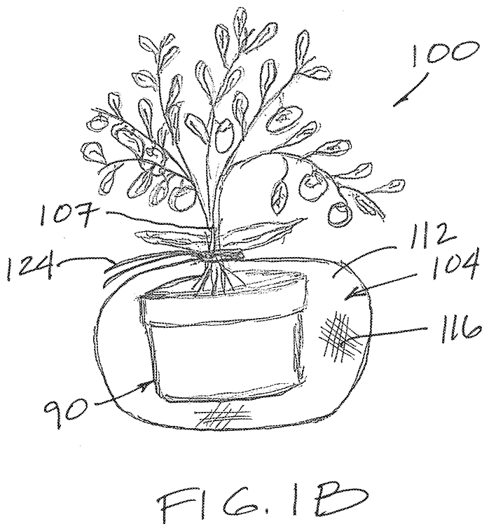

With reference now to FIGS. 3-8, different protective bag embodiments are shown. In the embodiments shown, the protective bags are depicted of a particular size and shape. However, the protective bags can be made to have any number of shapes and sizes such that a range of bags can be made available having different shapes, overall sizes, different accessible options, different closing mechanism options, different material types, and different mesh sizes. The protective bags can also be custom made to order and to fit any number of shapes and sizes.

Different material options are available for use to form protective bags in accordance with aspects of the invention. PTFE coated fiberglass fabrics are excellent for durability, dimensional stability, and tensile strength and can be used to make protective bags as provided herein, and they come in different mesh sizes.

Non-woven fabrics are also good candidates for use to make protective bags in accordance with aspects of the invention. Non-woven fabrics are flexible, porous, and usually consist of one or more fiber layers. The fibers are typically bonded by chemical, thermal or mechanical processes to form a matrix or frame of the fabric material having an array of pores, which can be made in different mesh sizes. Durable non-woven fabrics can be re-used, washed, and tailored to different sizes and shapes. They can be made from polyester, nylon, textured polyester, high-tenacity (HT) nylon, stretched nylon, and a combination of nylon and polyester, among others. These fabrics may be referred to as meshed-material sheets or fabrics.

FIG. 2A shows an alternative embodiment of the invention, which shows a hydroponic system 140 comprising a base 142 defining a plant bed with an array of plant receptacles 144 are shown, each with a plant 100, similar to FIG. 2 but with a smaller array of receptacles. Each plant receptacle 144 can have an inert medium, such as perlite, rockwool, clay pellets, peat moss, or vermiculite for supporting the respective plant's root system. In the present embodiment, individual protective bags 104 are used with plants 100 on an individual basis. That is, each plant 100 has its own protective bag 104 placed around the root system and the inert medium that supports the root system. The bag 104 is then closed around the trunk 107 of each plant, such as with a draw string. In some examples, the protective bags 104 of the present disclosure are sized and shaped to line large pots for large plants or trees. Often larger trees are planted in wooden containers and the protective bags 104. In an example, the protective bags of the present invention are provided with tear resistant fabrics for use with wooden containers.

With reference now to FIG. 3, a protective bag 104 having a bag body 104 is shown. In an example, the protective bag 104 is provided with a main opening 120 for accessing the interior 112 of the bag. The bag 104 may be made from a large meshed-material fabric that is folded widthwise or lengthwise and then bonded along a common side edge 168. The common side edge 168 can instead be stitched, welded, stapled, attached by snap-fittings, attached by Ziplock, attached by VELCRO, attached by buttons, attached by zippers, or combinations thereof. The joined layers of meshed-material fabrics using one or more of the disclosed joining options may generically be referred to as a joined edge, a joined section, or a joined strip of the bag.

A bag bottom 170 is located on an end opposite the main opening 120. In an example, the bag bottom 170 can be open-ended, which can be closed or sealed using a joined edge or joined strip, similar to the common edge 168, provided at the bottom perimeter 172. Alternatively, the bag bottom 170 can be provided with a bottom meshed fabric that is joined to the meshed fabric of the body 110 along the bottom perimeter 172 as a joined edge. As used herein, the main opening 120 can be referred to as a first end and the bag bottom 170 can be referred to as a second end. In an example, the main opening or first opening at the first end 120 can have a larger diameter than the diameter at the second end.

In an example, the first end 120 and the second end 170 can be closed as a joined edge or a joined strip, as those terms have been defined. Alternatively, the first end and/or the second end can be closed using drawstrings, similar to those used to close an open end of a typical fabric carrying bag. FIG. 3 depicts a band 178 at the first end 120, which can be a VELCRO, snap fittings, or any of the options described elsewhere herein for closing the first end.

In an example, the body 110 of the protective bag 104 can be provided with a closable seam 164. The closeable seam 164 can be formed by creating a split in the body 110 to form two edges 164a, 164b and then providing each edge with an attachment mechanism. For example, the first edge 164a can be provided with a strip 178a of hooks and the second edge 164b can be provided with a strip 178b of loops, similar to a VELCRO brand of hook and loop fasteners. The attachment mechanism can instead be snap-fittings, a ZIPLOCK, buttons, a zipper, or combinations thereof. The closeable seam 164 may be incorporated to access the interior 112 of the protective bag or to enable placement of a potted plant into the interior of the protective bag. The bag 104 can be sized and shaped to fit any number of potted plants, including being sufficiently large to accommodate both a plant top and a plant bottom, such as the root system of the plant, or being sized and shaped to accommodate a hydroponic system. As shown with reference to FIGS. 1A, 1B, and 2A, the protective bag can also be sized and shaped to accommodate the plant root system and the support system for the plant roots, with or without a pot.

In an example, an access window 180 can be provided with the protective bag 104. The access window 180 can include a cover flap 182 that blocks or covers an opening 184 formed through the body 110 of the protective bag 104. The cover flap 182 can be formed as a cut-out along three edges of the meshed fabric of the body or can be attached to the body along one of the four edges of the flap. The other edges of the flap can be removably secured to the meshed fabric of the body using a removable fastener, such as buttons, snap fittings, VELCRO, etc. The access window 180 may be incorporated to access the interior 112 of the protective bag, such as for watering or pruning the plant located therein.

For the protective bags 104 disclosed herein, it is understood that where a feature is shown but not expressly described and is otherwise the same or similar to the feature or features described elsewhere, such as above with reference to FIGS. 1-3, the disclosed part or parts shown in all the drawing figures but not expressly described because of redundancy and because knowledge is built on a foundation laid by earlier disclosures may nonetheless be understood to be described or taught by the same or similar features expressly set forth in the text for the embodiments in which the feature or features are described. Said differently, subsequent discussions of the present application are built upon the foundation of earlier discussions unless the context indicates otherwise. The application disclosure is therefore understood to teach a person of ordinary skill in the art the disclosed embodiments and the features of the disclosed embodiments without having to repeat similar components and features in all embodiments since a skilled artisan would not disregard similar structural features having just read about them in several preceding paragraphs nor ignore knowledge gained from earlier descriptions set forth in the same specification. As such, the same or similar features shown in the following protective bags 104 incorporate the teachings of earlier embodiments unless the context indicates otherwise. Therefore, it is contemplated that later disclosed embodiments enjoy the benefit of earlier expressly described embodiments, such as features and structures of earlier described embodiments, unless the context indicates otherwise.

With reference now to FIG. 4, a protective bag 104 is shown having a body 110 formed by joining a plurality of meshed fabric panels 188 along common side edges 168 to form bag with a plurality of joined edges, joined sections, or joined strips, as those terms have been described elsewhere herein. As shown, the protective bag 104 is formed by joining six meshed fabric panels 188 together. In other examples, a different number of meshed fabric panels may be used, such as fewer than six or more than six panels. Additionally, one or more seams 164 and/or one or more access windows 180 (FIG. 3) may be provided with the protective bag.

The first end 120 and the second end 170 may each be provided with an end meshed sheet that is attached to the respective first end perimeter and second end perimeter. Alternatively, only the second end 170 is provided with an end meshed sheet that is attached to the second end perimeter and the first end can be closed using a draw string 124, which can have two free ends for pulling or formed as a closed loop as shown, which is similar to those commonly found with large plastic trash bags. The draw string 124 in the present embodiment and other embodiments described elsewhere herein can be attached to the protective bag 104, such as wound through a passage within the bag, or unattached, such as simply wrapped around the outside of the bag 104. In yet other examples, the protective bag 104 can have two open ends, such as an open first end 120 and an open second end 170, so that the protective bag can close up or close in against two spaced apart structures or elements. For example, the protective bag 104 can have an open first end with a drawstring to close against the trunk of a plant or tree and an open second end with a drawstring to close against a pot or the root system of the plant or tree.

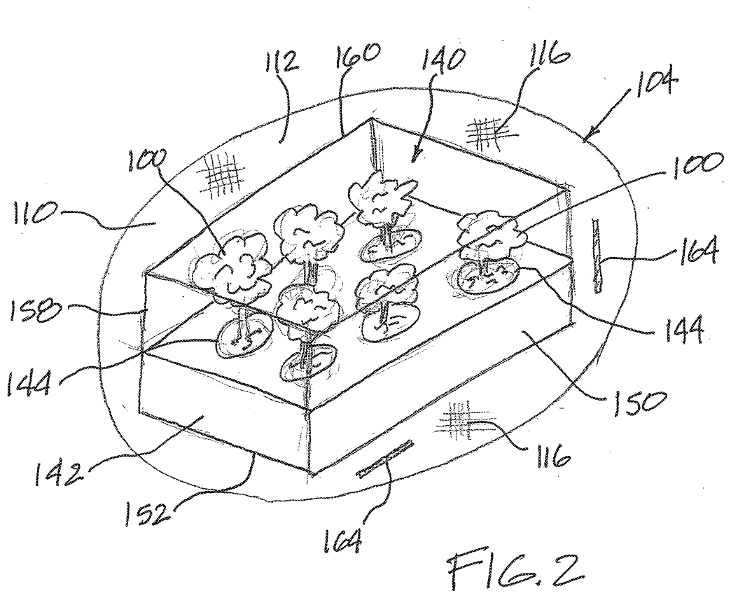

With reference now to FIG. 5, a protective bag 104 is shown having a body 110 formed by joining a plurality of meshed fabric panels 188 along common side edges 168 to form bag with a plurality of joined edges, joined sections, or joined strips, as those terms have been described elsewhere herein. As shown, the protective bag 104 is formed by joining four meshed fabric panels 188 together. The panels can have different panel sizes. For example, the front and back panels can be larger than two side panels thus forming a shopping bag like protective bag. As shown, the side panels can each be folded with a crease.

In an example, the first end 120 and the second end 170 may each be provided with an end meshed sheet that is attached to the respective first end perimeter and second end perimeter. Alternatively, only the second end 170 is provided with an end meshed sheet that is attached to the second end perimeter and the first end can be closed using a draw string 124 or one of the joining means disclosed elsewhere herein.

An access window 180 can be provided with the body 110. Handles or straps 190 can also be provided with the body 110 to facilitate carrying the protective bag and contents inside. Additionally, one or more seams 164 and/or more than one access window 180 (FIG. 3) may be provided with the protective bag.

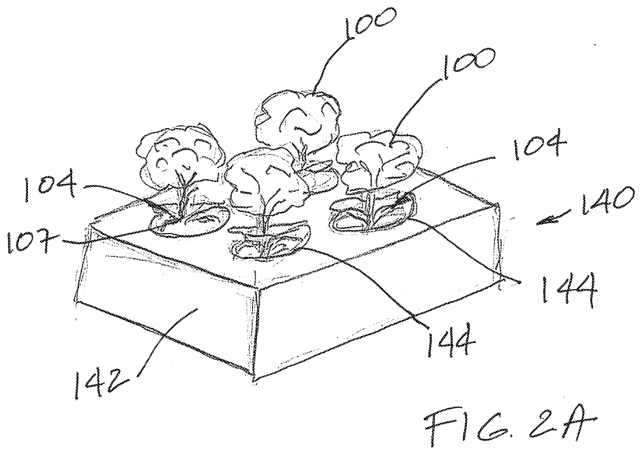

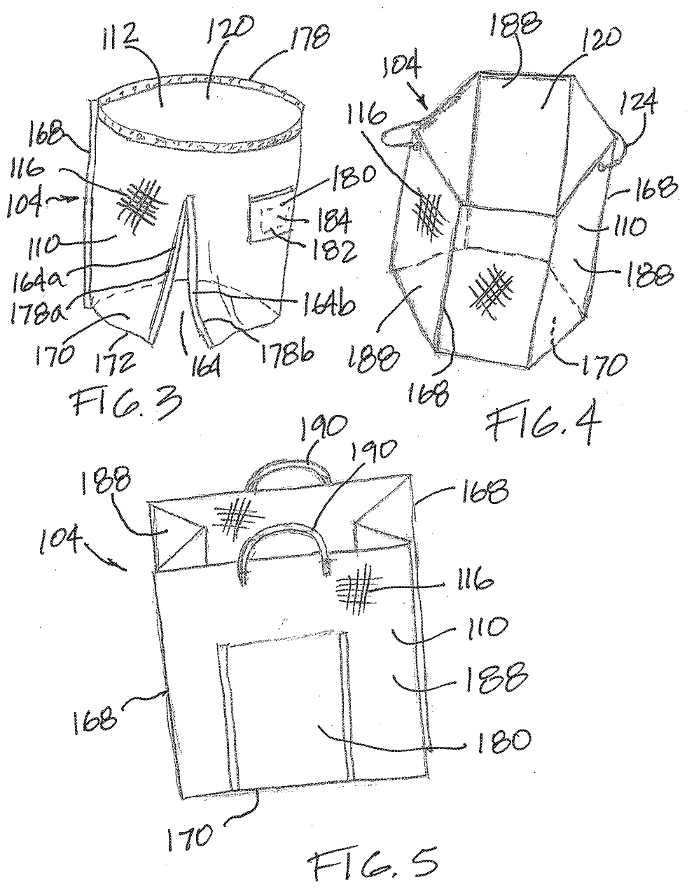

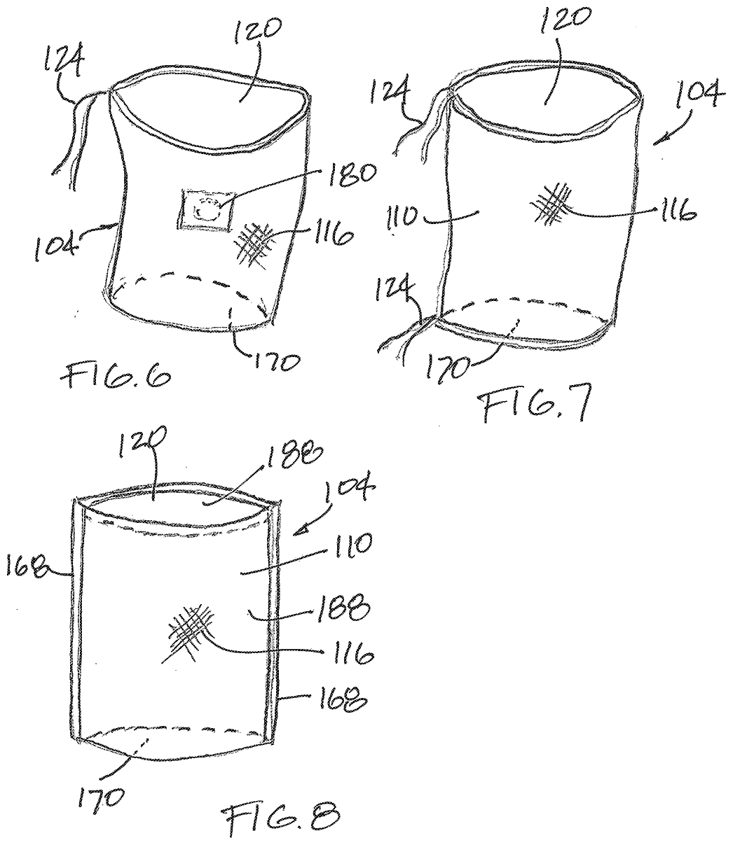

With reference now to FIG. 6, a protective bag 104 is shown having a body 110 formed by a drawn meshed-fabric tube, rather than folding or joining panels together. In an example, the first end 120 and the second end 170 may each be provided with an end meshed sheet that is attached to the respective first end perimeter and second end perimeter. Alternatively, only the second end 170 is provided with an end meshed sheet that is attached to the second end perimeter and the first end can be closed using a draw string 124 or one of the joining means disclosed elsewhere herein. Additionally, one or more seams 164 and/or more than one access window 180 (FIG. 3) may be provided with the protective bag.

FIG. 7 shows a protective bag 104 having a body 110 formed by a drawn meshed-fabric tube, rather than folding or joining panels together, like the protective bag of FIG. 6. In the present example, the first end 120 and the second end 170 are each provided with a draw string 124 or one of the joining means disclosed elsewhere herein. Additionally, one or more seams 164 and/or one or more access windows 180 (FIG. 3) may be provided with the protective bag.

FIG. 8 shows a protective bag 104 having a body 110 formed by joining two meshed fabric panels 188 along two common side edges 168 to form bag with a plurality of joined edges, joined sections, or joined strips, as those terms have been described elsewhere herein. The first end 120 and the second end 170 can be joined using any of joining means disclosed elsewhere herein. Additionally, one or more seams 164 and/or one or more access windows 180 (FIG. 3) may be provided with the protective bag.

FIG. 9 is a partial view depicting a seam 164, or the first end or second end, of a protective bag. The seam 164 can have a first edge 164a and a second edge 164b and a first attachment mechanism 178a on the first edge and a second mechanism on the second edge. In the present embodiment, the first attachment mechanism can be buttons and the second attachment mechanism can be button slots for forming closing mechanism 194 in accordance with aspects of the invention.

FIG. 10 is a partial view depicting a seam 164 similar to FIG. 9 and wherein the closing mechanism 194 provided with the seam is a hook and loop fastener.

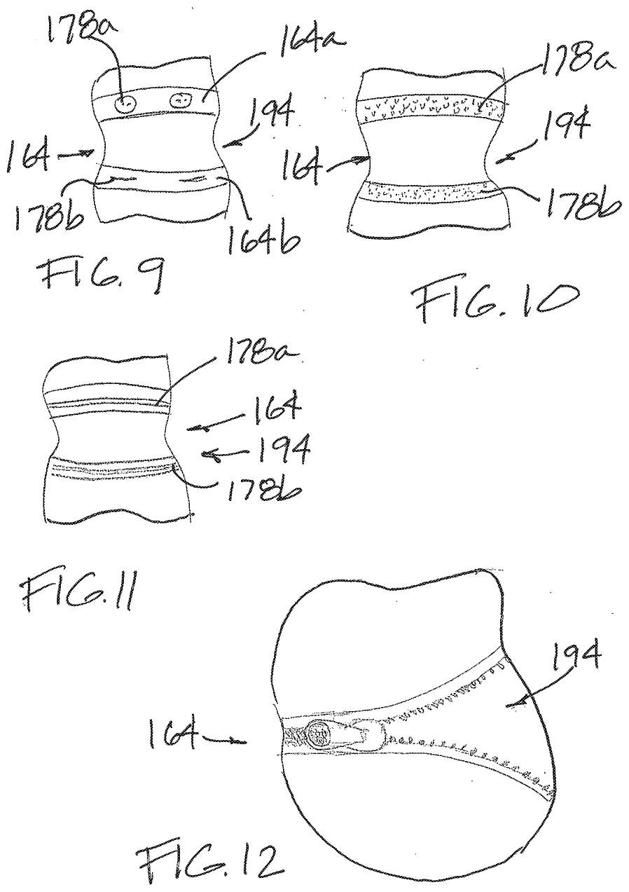

FIG. 11 is a partial view depicting a seam 164 similar to FIG. 9 and wherein the closing mechanism 194 provided with the seam is ZIPLOCK mechanism.

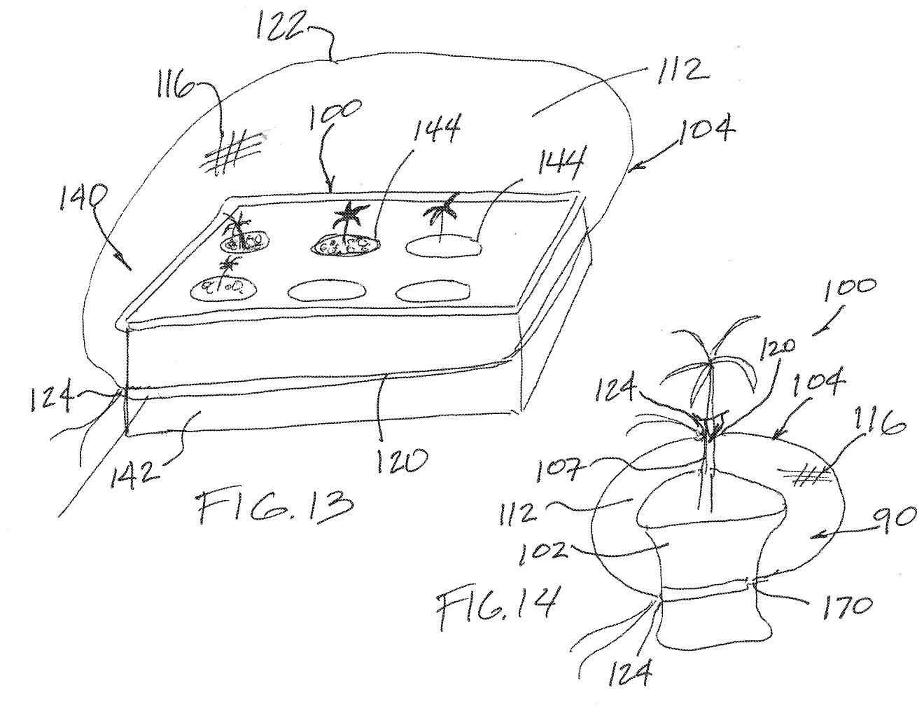

FIG. 12 is a partial view depicting a seam 164 similar to FIG. 9 and wherein the closing mechanism 194 provided with the seam is a zipper.

FIG. 13 shows an alternative embodiment of the invention, which shows a hydroponic system 140 comprising a base 142 defining a plant bed with an array of plant receptacles 144 are shown, some of which having a plant 100 located therein, similar to FIG. 2 and FIG. 2A. Each plant receptacle 144 can have an inert medium, such as perlite, rockwool, clay pellets, peat moss, or vermiculite for supporting the respective plant's root system. In the present embodiment, a single protective bag 104 is used to cover the hydroponic system 140. The protective bag can be made from the same materials as other protective bags described elsewhere herein.

As shown, the protective bag has a main opening 120 and an enclosed end 122. However, rather than placing the hydroponic system 140 through the main opening 120 and resting the hydroponic system 140 against the interior of the enclosed end 122, the present application uses a closure system 124, such as a drawstring, to close the main opening against the base 142. In some examples, the main opening 120 can be provided with adhesive for adhering against the side of the base 142. Access to the interior 112 of the protective bag 104 can be provided through one or more closeable seams 164 or access windows 180 (FIG. 3).

FIG. 14 shows yet another alternative embodiment of the invention, which shows a protective bag 104 with a potted plant 90, the protective bag being sized and shaped to accommodate and protect the plant's 100 root system only, like that of FIG. 1B. In the present embodiment, the protective bag 104 is sized and shaped for use to protect the plant's root system from root aphids and for use around the outside of the pot 102, similar to that of FIG. 1B. As shown, the plant 100 is planted in soil and the root system with the soil positioned in a pot and the combination located inside the interior 112 of the protective bag 104. However, unlike the embodiment of FIG. 1B, the present protective bag 104 has two open ends 120, 170 with two different closure systems 124, such as drawstrings, adhesives, Velcro, etc. The first open end 120 can be drawn closed against the trunk 107 of the plant 100 while the second open end 170 can be drawn closed around the pot 102. The bag 104 can made from a porous material as previously described so that water and/or plant food can be delivered to the plant's root system through the porous layer of the protective bag. In alternative embodiments, the root system can be supported by an inert medium, such as perlite, rockwool, clay pellets, peat moss, vermiculite or other known hydroponic system inert mediums.

In an exemplary embodiment, a protective bag described elsewhere herein can be placed in the ground for use with planted plants. For example, a hole can be dug up in the ground, a protective bag provided herein is then placed into the hole, soil is then placed into the bottom of the bag and one or more plants or one or more seeds placed inside the protective bag with the soil to be grown inside the protective bag with the bag placed into the dug-up hole.

In some examples, plastics, cotton, or cotton-blend cloth can be used as the base fabric for making protective bags described herein. These alternative materials can also be provided in meshed forms.

In some examples, modular panels can be provided to allow the grower or user to join any number of them together as needed to form a protective bag of the size and shape as desired. The various panels can be provided with a closing or joining mechanism described elsewhere herein to join the panels together.

As plants are placed inside the protective bags of the invention, the plants, such as the root system, can at least be protected from direct harmful UV light.

The various meshed materials and panels described herein can be provided with different colors, different coloring schemes, and with indicia, such as text, pictures, and/or numbers. The different colors, coloring schemes, and indicia can help to track and sort the plants by crop, type, size, etc.

The various protective bags described herein can be reversible for use both sides if needed and can be machine washable for re-use. Additionally, the fabric or meshed materials can be infused with agents that are known to repel pests, such as citronella, peppermint oil, cinnamon, clove, rosemary, thyme, organic oils such as neem oils, etc.

Methods of making and of using the protective bags and components thereof are within the scope of the present invention.

Although limited embodiments of protective bags and their components have been specifically described and illustrated herein, many modifications and variations will be apparent to those skilled in the art. Accordingly, it is to be understood that the protective bags and their components constructed according to principles of the disclosed devices, systems, and methods may be embodied other than as specifically described herein. The disclosure is also defined in the following claims.

What is claimed is:

1. A method for protecting a plant having a plant top section and a plant root system, said method comprising:
providing a protective bag having a bag body defining an interior, a first end, and a second end;
placing the plant root system, at least in part, inside the interior of the bag body through the first end;
closing in the first end; and
wherein the protective bag is made from a meshed-material sheet or fabric.

2. The method of claim 1, wherein the second end is provided with an end meshed sheet that is attached to a second end perimeter.

3. The method of claim 1, wherein the bag body is provided with one or more seams.

4. The method of claim 1, wherein the bag body is provided with one or more accessible windows.

5. The method of claim 1, wherein the meshed-material sheet is made from a PTFE coated fiberglass fabric or from non-woven fabric.

6. The method of claim 1, wherein the protective bag is placed into a dug-up hole in the ground.

7. The method of claim 1, wherein the plant is grown in a hydroponic system.

8. The method of claim 1, wherein the meshed-material sheet or fabric has a mesh size of less than 2 mm.

9. The method of claim 1, where the meshed material sheet or fabric has at least one fold.

10. The method of claim 1, wherein the protective bag is placed into a wooden container.

11. The method of claim 1, wherein both the plant top section and the plant root system are placed inside the interior of the bag.

12. The method of claim 1, wherein the first end, the second end, or both the first end and the second end are provided with a closure system.

13. The method of claim 12, wherein the first end is closed tight against the plant top section, the second end is closed tight against a pot or a base, or both the first end is closed tight against the plant top section and the second end is closed tight against a pot or a base.

14. A protective bag for use with a potted plant, said protective bag comprising:
a bag body defining an interior, a first end, and a second end; the bag body being made from a meshed-material sheet or fabric;
a closing mechanism at the first end for closing the first end, said closing mechanism comprising at least one of stitching, bonding, welding, stapling, snap-fittings, ZIPLOCK, VELCRO, buttons, zippers, or combinations thereof; and
wherein the protective bag body is sized and shaped to accommodate an entire plant's top section and plant root system or just the plant root system.

15. The protective bag of claim 14, further comprising a closing mechanism at the second end for closing the second end, said closing mechanism at the second end comprising mechanism comprising at least one of stitching, bonding, welding, stapling, snap-fittings, ZIPLOCK, VELCRO, buttons, zippers, or combinations thereof.

16. The protective bag of claim 14, further comprising at least common edge joining two edges of the bag body together.

17. The protective bag of claim 16, further an opening defining an access window through the bag body and a flap closable over the opening.

18. A method for protecting a plant having a plant top section and a plant root system, said method comprising:
providing a protective bag having a bag body defining an interior, a first end, and a second end;
placing the plant root system, at least in part, inside the interior of the bag body through the first end;
closing in the first end below the plant top section using at least one stitching, bonding, welding, stapling, snap-fittings, ZIPLOCK, VELCRO, buttons, zippers, or combinations thereof; and
wherein the protective bag is made from a meshed-material sheet or fabric.

19. The method of claim 18, further comprising closing in the second end against an exterior of a pot having the plant root system located therein.

20. The method of claim 20, The method of claim 18, further comprising closing in the second end contain an inert medium; wherein said inert medium comprising at least one of perlite, rockwool, clay pellets, peat moss, and vermiculite.
